(19) United States
(12) Patent Application Publication
(10) Pub. No.: US 2006/0211538 A1
(43) Pub. Date: Sep. 21, 2006

(54) Hydraulic system for supply of the secondary circuit of a continuously variable belt drive transmission of a motor vehicle

(76) Inventors: Anton Fritzer, Markdorf (DE); Tobias Pfleger, Friedrichshafen (DE)

Correspondence Address: DAVIS & BUJOLD, P.L.L.C., 112 PLEASANT STREET, CONCORD, NH, 03301, US

(21) Appl. No.: 11/376,039

(22) Filed: Mar. 15, 2006

(30) Foreign Application Priority Data
Mar. 17, 2005 (DE) 102005012256.6

(51) Int. Cl. F16H 61/662

(52) U.S. Cl. 477/45

(57) ABSTRACT

A hydraulic system for supply of the secondary circuit (S) of a continuously variable belt drive transmission of a motor vehicle is proposed in which there is provided for adjusting the pressure (p_S1) of the primary pulley (S1), a primary valve (PRIV) and the pressure (p_S2) of the secondary pulley (S2) a secondary valve (SEKV) which are respectively controlled by one pressure regulator (EDS_S1, EDS_S2) comprising one pressure-selector valve between the primary valve (PRIV) and the secondary valve (SEKV) the adjustment of which determines whether the primary or the secondary valve (PRIV, SEKV) adjusts the main pressure to be conveyed by the oil pump (P) of the hydraulic system and in which the oil is supplied to the secondary circuit (S) via the pressure-selector valve (DAV).

This application claims priority from German Application Serial No. 10 2005 012 256.6 filed Mar. 17, 2005.

### FIELD OF THE INVENTION

The invention concerns a hydraulic system for supply of the secondary circuit of a continuously variable belt drive transmission of a motor vehicle.

### BACKGROUND OF THE INVENTION

A continuously variable belt drive transmission usually consists of one starting unit, preferably a converter, one forward/reverse unit, one reversing set, one intermediate shaft, one differential, hydraulic and electronic control devices and one variator.

In transmission of this type according to the prior art, the variator comprises one primary side connected with a drive shaft and one secondary side comprising each bevel pulleys disposed in pairs. One of the bevel pulleys is stationarily situated in axial direction, the other being movably disposed. The axially movable pulley of the primary side is usually called a primary pulley and the other one of the secondary side a secondary pulley. One variator is also provided with a torque-transmitting belt drive element, which revolves between two bevel pulley pairs. The belt drive element is customarily used as a sliding jointed band, a drag chain or a belt. The actual ratio of the transmission is defined by the running radius of the belt drive element which, in turn, is a function of the axial position of the bevel pulleys of the primary and the secondary side.

According to the prior art, the axial position, relative to each other, of the respect bevel pulleys of the primary and the secondary sides is hydraulically adjusted. A hydraulic pressure is here applied to the movable bevel pulleys, that is, to the primary and the secondary pulleys, in a manner such that the axial distance of the bevel pulleys of a bevel pulley pair, relative each other, is adjustable as a function of the pressure.

The Applicant's DE 101 46 962 A1 discloses a hydraulic system of a continuously variable belt drive transmission in which a pressure-selector valve is situated between the valve devices (primary and secondary valves) coordinated with the respective pulley sets of the primary and secondary sides. By the position of the pressure selector valve is here determined whether the primary or the secondary valve adjusts the main pressure to be conveyed by the oil pump of the hydraulic system. It is further provided that the secondary circuit of the transmission comprising a cooling, a lubricating and other consumers be connected to the secondary valve, the oil being supplied to the secondary circuit with excess oil volume on the secondary valve which is discharged in the secondary circuit.

The described supply of the secondary circuit, via the secondary valve, produces flow forces, the amount of which depends on the pressure drop in the secondary valve and on the amount of oil. In some transmission constructions, in turn, this can have a negative effect on the reduction ratio.

The problem on which this invention is based is to outline a hydraulic system for supply of the secondary circuit of a continuously variable belt drive transmission of a motor vehicle which overcomes the disadvantages mentioned in the prior art. In particular, a sufficient supply of the secondary circuit is to be ensured without negatively affecting the reduction ratio of the variator.

### SUMMARY OF THE INVENTION

Accordingly, a hydraulic system is proposed for supply of the secondary circuit of a continuously variable belt drive transmission of a motor vehicle which contains one primary valve for adjusting the pressure of the primary pulley and one secondary valve for adjusting the pressure of the secondary pulley, comprising a pressure-selector valve situated between the primary valve and the secondary valve and whose position determines whether the primary or the secondary valve adjusts the main pressure to be conveyed by the oil pump of the hydraulic system where the oil is supplied to the secondary circuit via the pressure-selector valve.

In the inventive hydraulic system, one primary valve is provided for adjusting the pressures of the primary pulley and one secondary valve for adjusting the pressures of the secondary pulley; each controlled by a pressure regulator. The supply pressure of the pressure regulators is, in addition, reduced by a pressure-reducing valve from the pressure that abuts in the line inflow direction after the pump and the primary valve, the secondary valve and the pressure-selector valve or main pressure valve before the pressure-reducing valve. The main pressure is also adjusted by the pressure-selector valve so as to be higher by one offset than the pulley pressure to be adjusted, the pressure-selector valve is controlled either by the control pressures of the pressure regulators or via the pressures of the primary and secondary pulleys.

For the case that the pressure-selector valve is controlled by the pressures of the pressure regulators, the advantage results that slighter pressure act upon the stop of the hole of the pressure-selector valve. On the other hand, the use of the pulley pressures as control pressures results in the advantage that one step in the valve hole can be eliminated. The need of a separate pressure regulator for the main pressure valve is advantageously eliminated.

### BRIEF DESCRIPTION OF THE DRAWING

The invention is explained in detail herebelow as an example with reference to the enclosed Figure which

FIG. 1 shows a diagrammatic representation of the hydraulic system for supply of the secondary circuit of a continuously variable belt drive transmission.

### DETAILED DESCRIPTION OF THE INVENTION

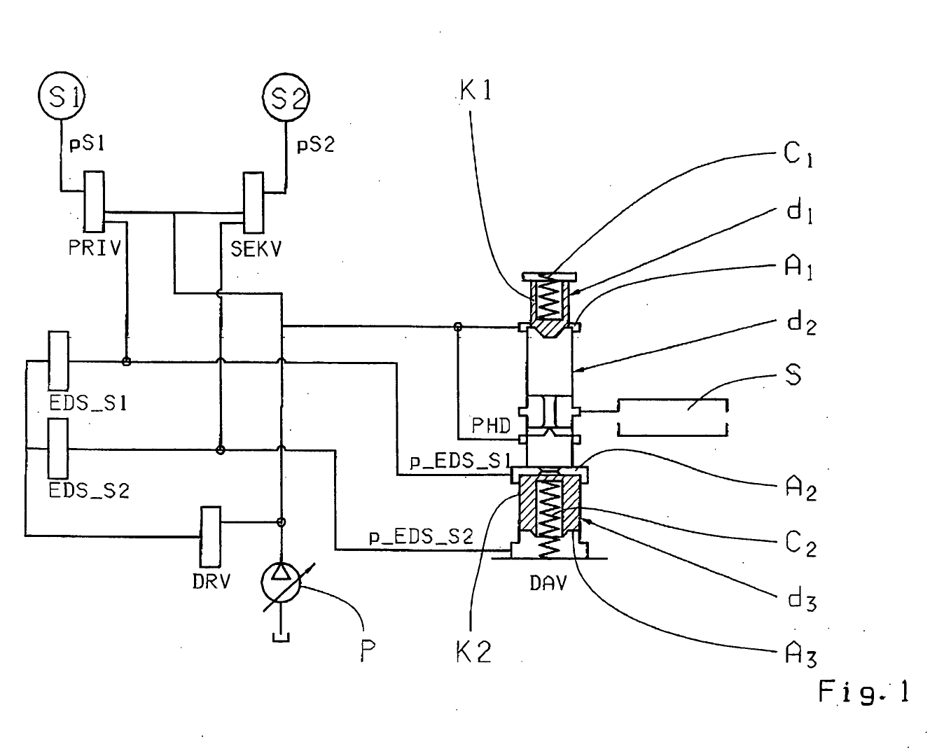

According to FIG. 1, the hydraulic system comprises one primary valve PRIV for adjusting a pressure pS1 of a primary pulley S1 and a secondary valve SEKV for adjusting a pressure pS2 of a secondary pulley S2; one pressure regulator EDS_S1 is assigned to the primary valve PRIV and one pressure regulator EDS_S2 is assigned to the secondary valve SEKV. The supply pressure of the pressure regulators EDS_S1 and EDS_S2 are a pressure reduced from the pressure delivered by a pump P by a pressure-reducing valve DRV.

In the alternative shown, a pressure-selector valve DAV is controlled by pressures p_EDS_S1 and p_EDS_S2 of the pressure regulators EDS_S1 and EDS_S2 and adjusts a main pressure PHD which is higher by one offset than the pulley pressure to be adjusted. According to the invention, a secondary circuit S is supplied by the pressure-selector valve DAV without negatively affecting the reduction ratio of the variator in the process.

The pressure-selector valve DAV, shown in FIG. 1 in slide version designed as 2-way valve, consists of one long valve piston K1 and one short valve piston K2. The control lines are connected so that for the case the pressure of the primary pulley or the control pressure p_EDS_μl is determinant, that is, when p_EDS_S1 is higher than p_EDS_S2, the short valve piston K2 is pressed against the plug. The valve characteristic line is given by the following equation

$${p}_{HD} = \frac{{p}_{EDSS1} * {A}_{2} - {F}_{C1}}{{A}_{1}} + {p}_{Flow} ,$$

wherein

A₁, A₂ are the corresponding surfaces

F_{C1} is the force of the spring

C₁p_flow of the flow pressure; and

PHD is the main pressure.

For the case that the pressure of the secondary pulley pS2 or of the control pressure p_EDS_S2 is determinant, the short valve piston K2 is pressed against the long valve piston K1 so that both pistons work as a unit. The valve characteristic line reads:

$$PHD = \frac{{p}_{EDSS2} * {A}_{3} - {p}_{EDSS1} * ( {A}_{3} - {A}_{2} ) + ( {F}_{C2} - {F}_{C1} )}{{A}_{1}} + {p}_{Flow} ,$$

wherein

A₁, A₂, A₃ are the corresponding surfaces,

F_{C1} is the force of the spring C₁,

C₁p_flow is the flow pressure, and

PHD is the main pressure.

Within the scope of advantageous developments of the invention for the short valve piston, one small shuttle valve or one rocker can be substituted.

In the embodiment shown, the springs of the pressure-selector valve DAV are interiorly situated so as to keep the length of the valve small. According to the invention, it is possible, depending on the layout, to eliminate one spring, for example, the spring C₁.

Any structural design, especially any spatial arrangement of the individual parts of the hydraulic system per se or relative to each other and insofar as technically relevance, obviously fall under the scope of protection of the instant claims without affecting the function of the hydraulic system such as indicated in the claims even if those designs have not been explicitly shown in the Figure or in the description.

### REFERENCE NUMERALS

PRIV primary valve
SEKV secondary valve
S1 primary pulley
S2 secondary pulley
pS1 pressure of the primary pulley
pS2 pressure of the secondary pulley
p_EDS_S1 control pressure of the primary pulley
p_EDS_S2 control pressure of the secondary pulley
EDS_S1 pressure regulator of the primary pulley
EDS_S2 pressure regulator of the secondary pulley
DRV pressure-reducing valve
P pump
PHD main pressure
DA pressure-selector valve
K1 valve piston
K2 valve piston
S secondary circuit
d1, d2, d3 valve pistons

1-5. (canceled)

6. A hydraulic system for supply of a secondary circuit of a continuously variable belt-drive transmission of a motor vehicle in which a primary valve and a secondary valve are provided for respectively adjusting a pressure of a primary pulley and a secondary pulley, the primary valve and the secondary valve are each controlled by a pressure regulator comprising a pressure-selector valve situated between the primary and the secondary valve, a position of the pressure regulator determines whether the primary or the secondary valve adjusts a main pressure to be conveyed by an oil pump of the hydraulic system;
wherein the secondary circuit (S) is supplied with oil via a pressure-selector valve (DAV).

7. The hydraulic system for supply of the secondary circuit of the continuously variable belt drive transmission according to claim 6, wherein the main pressure (PHD) is adjusted by the pressure-selector valve (DAV) so as to be higher by an offset than a pulley pressure (pS1, pS2) to be adjusted, and the pressure-selector valve (DAV) is controllable either by a control pressures (pEDS_S1, pEDS_S2) of pressure regulators (EDS_S1, EDS_S2) or via the pressures (pS1, pS2) of the primary and the secondary pulleys (S1, S2).

8. The hydraulic system for supply of the secondary circuit of the continuously variable belt drive transmission according to claim 6, wherein the pressure-selector valve (DAV) is constructed as a 2-way valve of a slide design which comprises a long valve piston (K1) and a short valve piston (K2), and control lines are connected such that when a pressure of the primary pulley (pS1) or a control pressure (p_EDS_1) is determinant, the short valve piston (K2) is forced against a stop of the pressure-selector vale (DAV) and, when a pressure of the secondary pulley (pS2) or the control pressure (p_EDS_2) is determinant, the short valve piston (K2) is forced against the long valve piston (K1) so that both pistons (K1, K2) work as a unit.

9. The hydraulic system for supply of the secondary circuit of the continuously variable belt drive transmission according to claim 8, wherein for the short valve piston (K2) one of a ball shuttle valve and a rocker is utilized.

10. The hydraulic system for supply of the secondary circuit of the continuously variable belt drive transmission according to claim 8, wherein the pressure-selector valve (DAV) has springs which are situated in an interior thereof.

11. A hydraulic system for suppling pressure to a secondary circuit of a continuously variable belt-drive transmission of a motor vehicle, the hydraulic system comprising:
a primary valve for adjusting a pressure of the primary pulley, and the primary valve being regulated by a primary pressure regulator;
a secondary valve for adjusting a pressure of the secondary pulley, and the secondary valve being regulated by a secondary pressure regulator;
a pressure-selector valve communicating with the primary valve and the secondary valve, and a position of the pressure selector valve determining which of the primary valve and the secondary valve adjusts a main pressure to be conveyed by an oil pump of the hydraulic system; and
a secondary circuit is supplied with hydraulic fluid via the pressure-selector valve.
